(19) United States
(12) Patent Application Publication
(10) Pub. No.: US 2013/0226958 A1
(43) Pub. Date: Aug. 29, 2013

(54) METHOD ENABLING USERS TO AUTOMATICALLY UPDATE AND SHARE CONTACT INFORMATION

(71) Applicant: Harry M. Pianko, Birmingham, MI (US)

(72) Inventor: Harry M. Pianko, Birmingham, MI (US)

(21) Appl. No.: 13/780,888

(22) Filed: Feb. 28, 2013

Related U.S. Application Data
(60) Provisional application No. 61/604,305, filed on Feb. 28, 2012.

(51) Int. Cl. G06F 17/30

(52) U.S. Cl. CPC G06F 17/30477
USPC 707/769

(57) ABSTRACT

A method that enables users to share and automatically update contact information. Profile information for a plurality of users is stored in an electronic, network-assessable database. Users may search for others in the database and add them as contacts. When the one user chooses to edit, add, or delete information from their stored profile information, the changes are automatically shared with the users designated as contacts by the one user. In contrast to existing contact-sharing schemes, however, the use of stored profiles makes the disclosed method much more versatile. Such profile information may include a phone number, e-mail address or social network address, with sub-profiles being assignable to personal, business, or other categories. This arrangement enables a given user to only share particular information to particular contacts, or allow a reciprocal relationship (sharing both ways). Users may additionally accept or deny information sharing by the other users.

### REFERENCE TO RELATED APPLICATION

This application claims priority to U.S. Provisional Patent Application Ser. No. 61/604,305, filed Feb. 28, 2012, the entire content of which is incorporated herein by reference.

### FIELD OF THE INVENTION

This invention is directed generally to contact sharing and, in particular, to methods that allow users to automatically update their contact information in other peoples' address books, contact lists, and other information in both web and smartphone environments.

### BACKGROUND OF THE INVENTION

“Contact information” was, at one time, shared manually. People gave each other their business cards or wrote their phone numbers down on little pieces of paper. People used Rolodexes and carried around Day-Timers. Times have changed. “Contact information” has grown overall with the advent of the Internet, electronic mail, social networking, and smart phones. Now, not only do people have several phones numbers in some cases, they have various email addresses and other web addresses.

With the advent of portable electronic devices, it is easier for individuals to store their own contact information, but it is increasingly difficult to share it with others, particularly when the information changes. Although this problem may not arise between family or close friends, it can arise more frequently with casual acquaintances like “Facebook friends.”

Although such problems may be alleviated by maintaining communication and diligently updating records, eventual loss or obsolescence of contact information is often inevitable. Moreover, if the wrong information is recorded with manual or even electronic methods, contact information may be gone for good. Increasingly, particularly with so-called cloud-based computing, mechanisms are being developed whereby contact information may be stored in a central repository to address issues with updating and distribution. For example, in accordance with U.S. Publication No. 2002/0156895, a user's contact information is stored in a database accessible over a network. A user can authorize access to the information to others with appropriate identification, enabling the user to store and re-store (i.e., update) his or her contact information such that others can access the most current contact information for the user.

Web-based contact management applications have also been introduced. In one approach, a subscriber enters contact information online, shares the information with other online subscribers and may download other subscribers' contact information to a proprietary application. Among the drawbacks of these systems are the use of proprietary contact management software and the requirement that both parties be subscribers to the web-based system. There are also issues with contact information falling into the wrongs hands, such as telemarketers.

The method described in U.S. Pat. No. 8,255,464 includes creating and storing a contact record in a contact management system, generating and storing a unique serial number corresponding to the contact record, and conveying the serial number to a recipient. The recipient may then enter the serial number into a network-enabled computer application, receive data associated with the contact record, and store the data in the application's database. A synchronization function enables network-enabled applications associated with the recipient to share contact information without re-entering the serial number.

Other approaches also feature automatic syncing to update contact information. For example, with the appropriate application Facebook will sync to one's smartphone, such that the smartphone user will have up-to-date contact information, including recent photographic portraits, as the case may be. While syncing mechanisms are convenient in most cases, they are non-discriminant; that is, all of one's contact information is shared with everybody, which is usually undesirable. For example, users typically don't want their business information to be shared with casual friends, and vice-versa. Thus, the need remains for a more customizable automated contact sharing system and method.

### SUMMARY OF THE INVENTION

This invention resides in a method enabling users to share and automatically update contact information. Profile information for a plurality of users is stored in an electronic, network-assessable database. Users may search for others in the database and add them as contacts. When the one user chooses to edit, add, or delete information from their stored profile information, the changes are automatically shared with the users designated as contacts by the one user.

In contrast to existing contact-sharing schemes, however, the use of stored profiles makes the disclosed method much more versatile. Such profile information may include a phone number, e-mail address or social network address, with sub-profiles being assignable to personal, business, or other categories. This arrangement enables a given user to only share particular information to particular contacts, or allow a reciprocal relationship (sharing both ways). Users may additionally accept or deny information sharing by the other users.

The method includes the step of maintaining prior or old profile information that may be searched, but which is not automatically shared with other users. The step of updating a user's profile information, and retrieving the contact information of others, is mediated through a one of several syncing processes disclosed herein.

### BRIEF DESCRIPTION OF THE DRAWINGS

FIG. 1 is a flow diagram that presents a syncing overview;

FIG. 2 is a flow chart that provides further syncing detail;

FIG. 3 depicts photo synching according to the invention;

FIG. 4 shows how data in contacts is replaced;

FIG. 5 is a flow diagram that illustrates the way in which a new contact is created on a device;

FIG. 6 illustrates a general process to sync oomphlink and a device; and

FIG. 7 depicts field mapping according to the invention.

### DETAILED DESCRIPTION OF THE INVENTION

This invention is directed generally to contact sharing and, in particular, to methods that allow users to automatically update their contact information in other peoples' address books, contact lists, and other information in both web and smartphone environments. Using the utility or service, referred to as “oomphlink” herein, each user creates a profile of information, which is stored in a database. The user can enter any piece of information, such as phone number, e-mail address, social network address, photographs, etc. Users may assign each piece of information to a sub-profile or sub-profiles, such as personal, business, or custom-created sub-profiles. The user can also choose to share the piece of information with “all,” meaning it is available in all sub-profiles.

The user then searches for other users in the database to add them as contacts. When adding users as contacts, a given user can choose to only share his or her information, only ask for the other user's information, or request a reciprocal relationship (sharing both ways). The other user then receives the request and may accept or deny it.

When choosing to let other users see a user's information, the user selects which sub-profiles to share with each given user. This allows each user to create a custom designed address book, with each user being able to define a custom set of information to share with each contact, based on the user's desire. When a user chooses to edit, add, or delete a piece of information from his or her profile, the user edits his or her profile, and the changes automatically populate into the contacts with whom he or she has originally shared this information.

### Profiles

Users maintain their own profiles by entering their information into the utility's database. Each piece of information is entered, and the user associates it with sub-profiles. Default sub-profiles of personal, business, and all (which associates the information with all sub-profiles) are available, as well as a custom option. Users can have as many sub-profiles as they choose. In order to create a custom sub-profile, the user selects the “Custom” option as a sub-profile, and names the sub-profile.

Each piece of information, including photos, is then associated with the sub-profile(s). A user can associate each piece of information with any number of sub-profiles. Then, the user chooses which sub-profile(s) to share with each contact. As an example, a user can choose to share a more whimsical photo with friends and a more professional photo with work colleagues.

Additionally, each user may have a prior sub-profile. This sub-profile is populated by any information the user deletes from his or her other sub-profiles. The user also can manually enter information into the prior sub-profile. Information in this sub-profile is only available to the user, but other users can search for information within the prior sub-profile.

### EXAMPLE

User A has three phone numbers: one assigned to a personal profile, one assigned to a business profile, and one assigned to “all.” User A then connects with User B, sharing his personal profile. User B can then view User A's personal and “all” phone numbers but not his business phone number. When User A gets a new personal phone number, he updates his profile, and this change is automatically reflected in User B's address book. However, when User A updates his oomphlink profile with a new business profile, User B's address book will not receive the update.

In addition to creating a custom designed address book, each user can view a running feed of other users' contact changes. This shows each contact's changes, so that the user knows when a piece of information is changed. Additionally, the user can receive an electronic notification listing the changes, as well as other information (for the users who entered such dates in their profiles) such as upcoming birthdays, anniversaries, etc.

This custom designed address book will automatically sync with the user's current address book(s). Plug-ins are used to sync the custom designed address book with desktop e-mail clients, such as Microsoft Outlook and Apple Mail. The address book may also be synced with web-based contacts, such as Google and Yahoo! by opening and closing browser windows in the background.

Applications, or apps, are also provided to sync the user's custom designed address book with the native address book of any smart phone. In addition to syncing the custom designed address book, the apps also allow all functionality that is available via the web to be performed on the phone. Via the phone app, users may update their profiles, add contacts, view recent updates, and so forth.

### Adding Contacts

Users have a number of ways to add contacts. There is a search field, which uses algorithms to compare data entered with user data in the database. Additionally, users can allow the utility to access their outside accounts, such as Facebook, Twitter, Yahoo!, Google, etc. With this access, the utility can search its database for information contained in a user's other accounts.

Contacts can also be added via direct applications for social networks, such as Facebook. Using Facebook as an Example, a user selects a group of friends with which he wants to share a custom address book and relationship. One example might be a reciprocal (sharing information both ways) relationship sharing the user's personal sub-profile. These selected friends then receive a direct message containing a link stating that the user wants to connect with them via the utility. By clicking the link, the friend is then connected to the user via the user's pre-determined relationship. In the case where the friend has not signed up for the utility, the friend's information is imported from the social network, and he or she is automatically signed up (and connected to the user). These applications can be created, using services such as Facebook Connect, for each outside service.

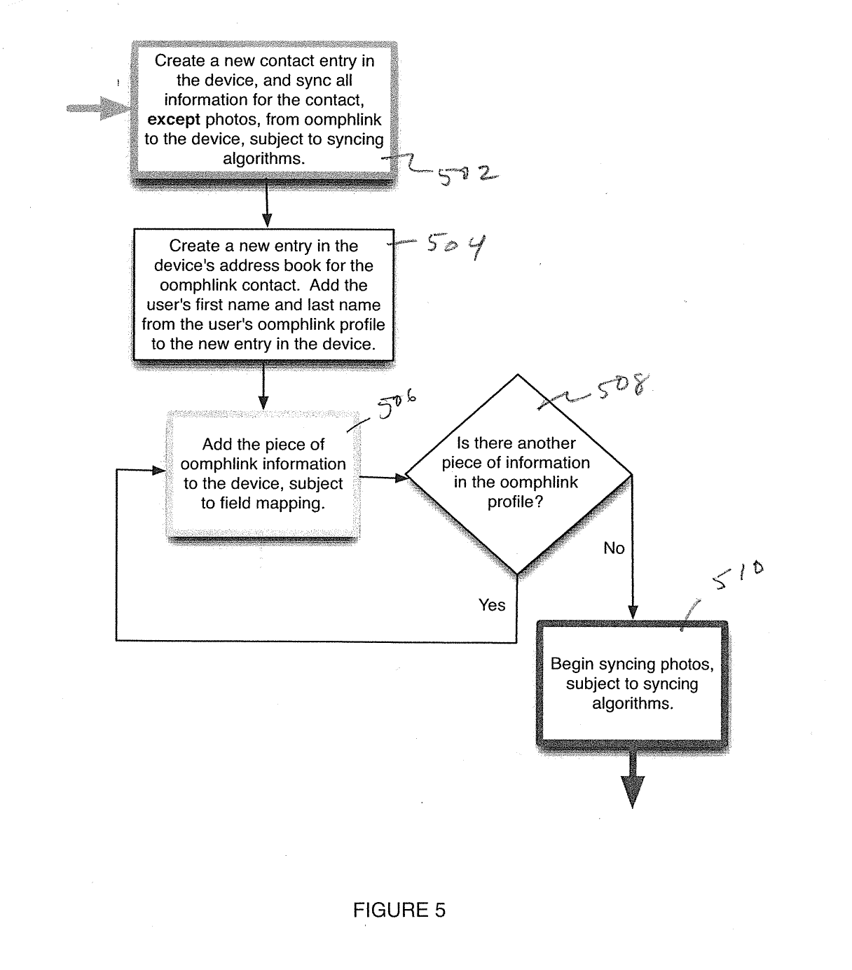

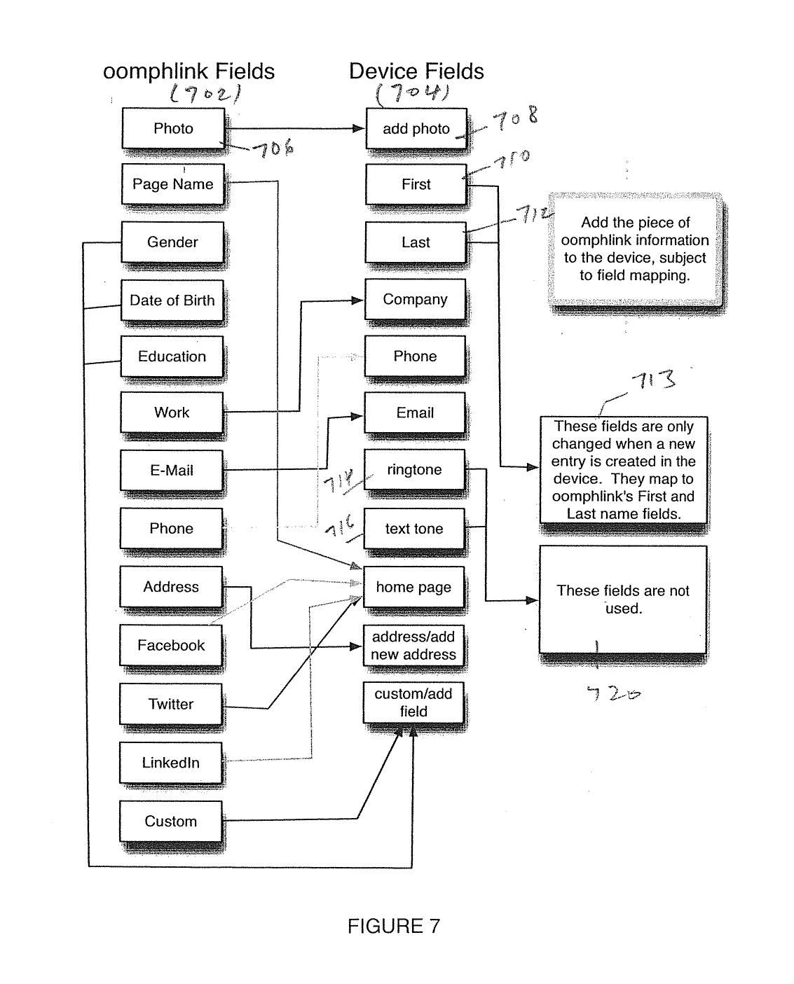

The way in which a new contact is created on a device is illustrated by the flow chart of FIG. 5. The process begins at 502. When a new contact entry is created in the device, all information is synced for the contact except photos, subject to syncing algorithms. At 504, a new entry is created in the device's address book, and the user's first and last name from the user's oomphlink profile are added to the new entry in the device. The piece of oomphlink information is added to the device at 506, subject to the field mapping illustrated in FIG. 7. If there is another piece of information to process at 508, flow returns to 506; if not, photo synching begins at 510, subject to syncing algorithms.

### Prior Information

Users may also maintain a list of their prior or old information. This list is populated in one of two ways: (1) the user directly enters information into the list, or (2) information removed from a user's active sub-profile(s) is automatically moved to prior information. A user can choose to remove information from the prior information sub-profile, which then removes it from the database.

Information in the prior sub-profile is only available to the user and cannot be shared with other users. However, it is fully searchable by all users. This serves two purposes: (1) a user can easily view a list of his or her old information, such as prior addresses; and (2) other users of the utility are able to search for someone's prior e-mail address, phone number, etc. This lets a user find his friends, etc. whose contact information has changed.

As an example, User A has a friend from college, User B. User B has changed his e-mail address from a university e-mail address to one from Google. However, User A only has User B's university e-mail address. User A searches for User B's university e-mail address and sees the match. User A can then request to view User B's information in his or her custom designed address book. If User B accepts the request, then User A will see User B's Google e-mail address.

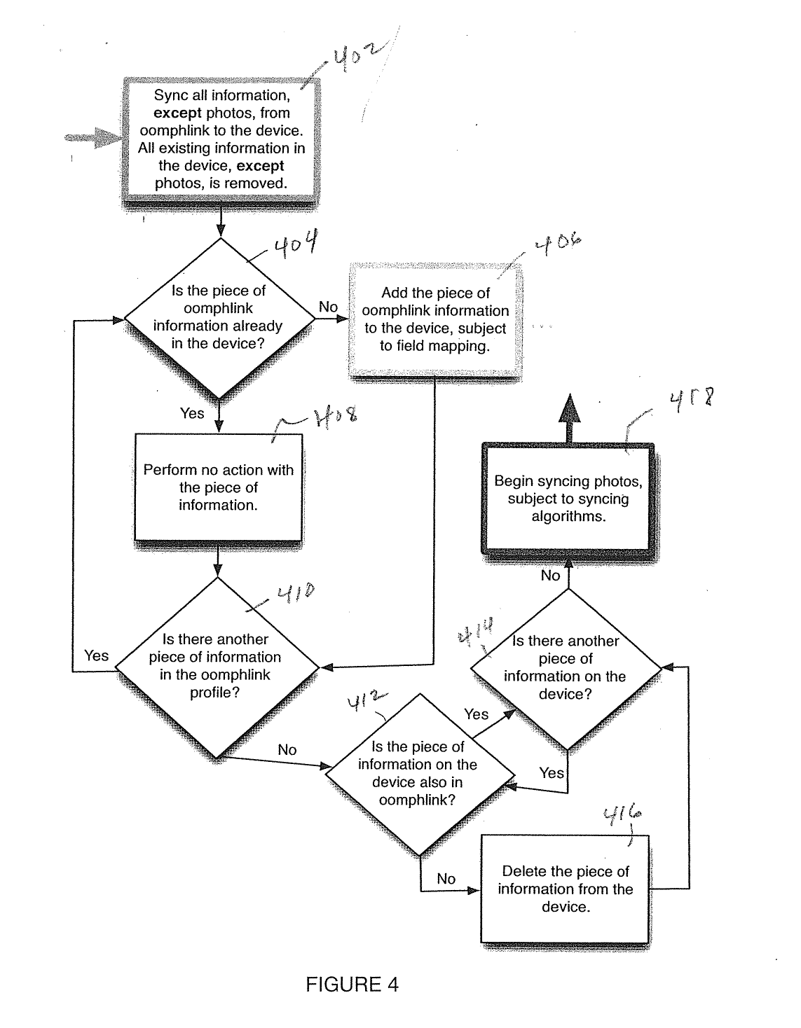

FIG. 4 shows how data in contacts is replaced. All information except photos is synced at 402, and all existing information in the device except photos is removed. At 404, if the oomphlink information is already in the device, no action is performed with that piece of information at 408. If, at 404, if the oomphlink information is not already in the device, it is added at 406, subject to the field mapping. After block 408, the question is asked at 410 if there is additional information. If so, control is returned to 404, whereas, if there is no more information, it is determined at 412 if the piece of information is also on oomphlink. If so, it is asked at 414 if there is another piece of information on the device. If so, control is returned to 412; if not, photo syncing begins at 418. If it is determined at 412 that the piece of information is also not on oomphlink, it is deleted at 416.

### Syncing

The method will sync information from its database to any user's chosen address book. Each user has options to allow the sync to either replace all information in the entry for each contact or add information that is not currently in the address book entry for each contact. The sync is only one way, from the utility to the user's address book. Users can edit their contacts' entries in their address books, but these changes do not update their contacts' entries in their custom address book in the utility. The only way for an entry in the utility's custom address book to be changed is for the person associated with the contact information to update it. This allows users to add or change information for their contacts in their own address books but keeps the integrity of the utility's database by only allowing people to edit their own information.

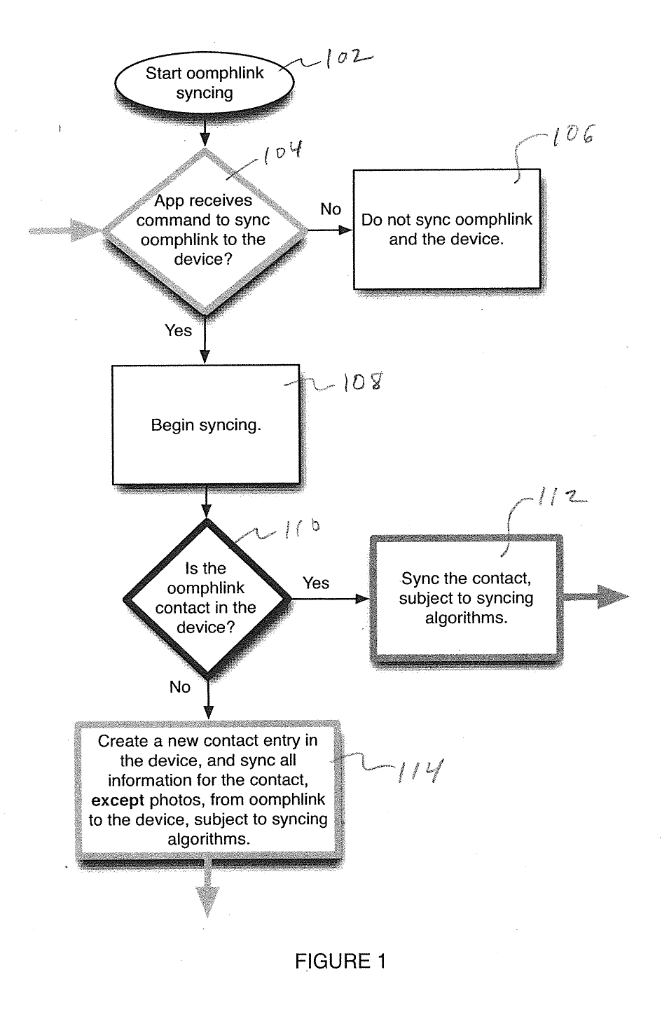

FIG. 1 is a flow diagram that presents a syncing overview. The process begins at 102. If, at 104, the app receives a command to start syncing, the process begins at 108; if not, syncing does not occur at block 106. Block 110 asks if the oomphlink contact is in the device. If so, the contact is synced at 112, subject to syncing algorithms. If the oomphlink contact is not in the device, a new contact is created at 114, including non-photo information, from oomphlink to the device, again subject to the syncing algorithms.

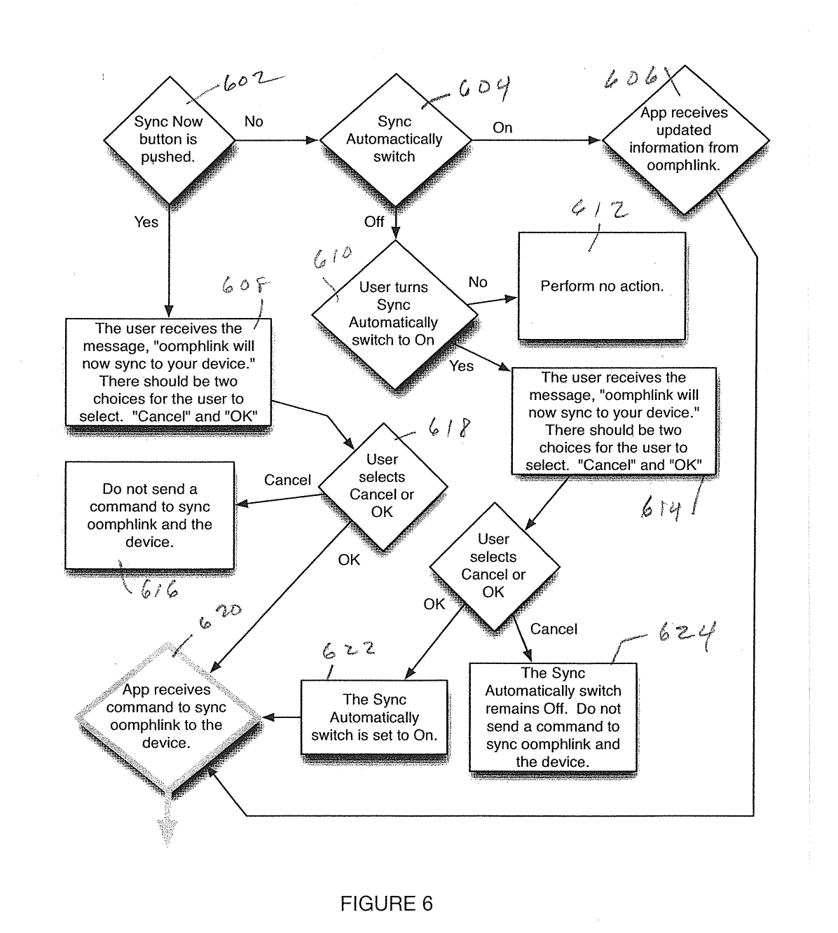

FIG. 6 illustrates a general process to sync oomphlink and a device. If the “sync now” button is pushed at 602, the user is informed at 608 that the syncing process will begin. The user can proceed or cancel the operation. If, at 618, the user selects cancel, a sync command is not sent at 616. If syncing is chosen, the app receives the command to sync oomphlink at 620. If the “sync now” button is not pushed at 602, block 604 asks if the “sync automatically” switch is on. If so, the app receives updated information from oomphlink at 606, and control flows to 620. If the “sync automatically” switch is off, 610 asks if the user turns the “sync automatically” switch to on. If not, no action is taken at 612. If the “sync automatically” switch to on, the user is informed at 614 that the syncing process will begin. Again, the user can proceed or cancel the operation. If the user wishes to proceed, the “sync automatically” switch is set to on and flow goes to 620. If the operation is cancelled, the “sync automatically” switch remains off at 624, and a command is not sent to sync oomphlink and the device.

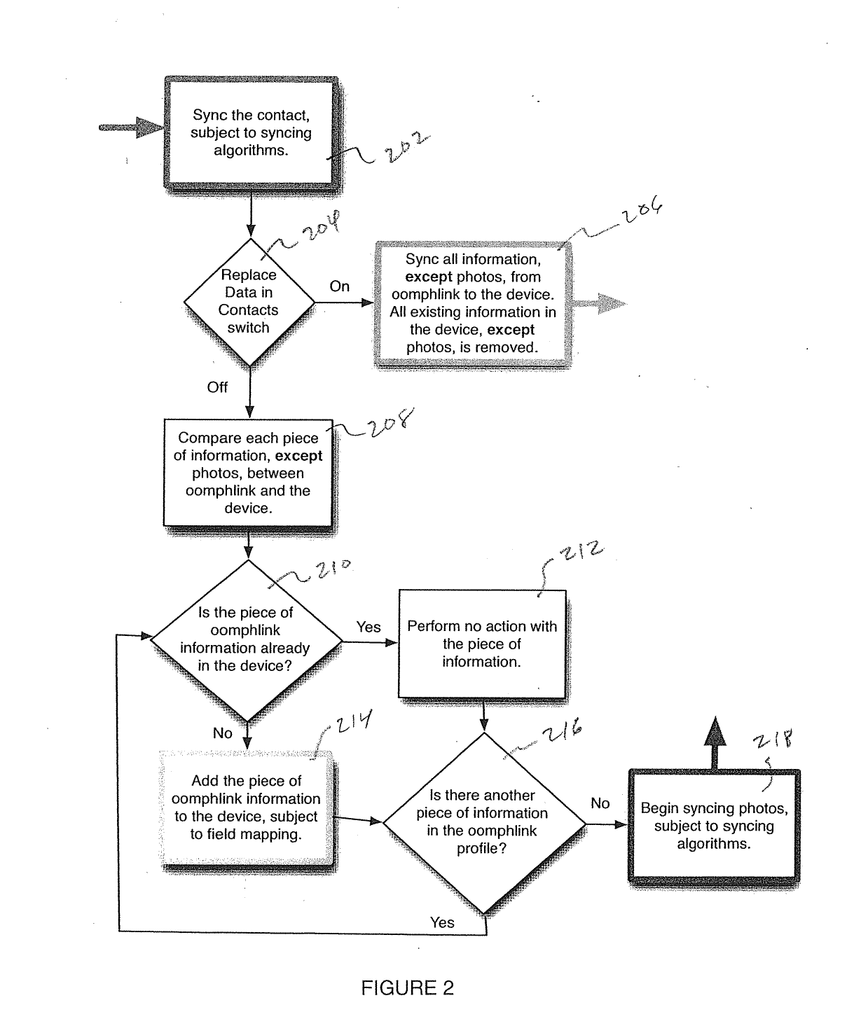

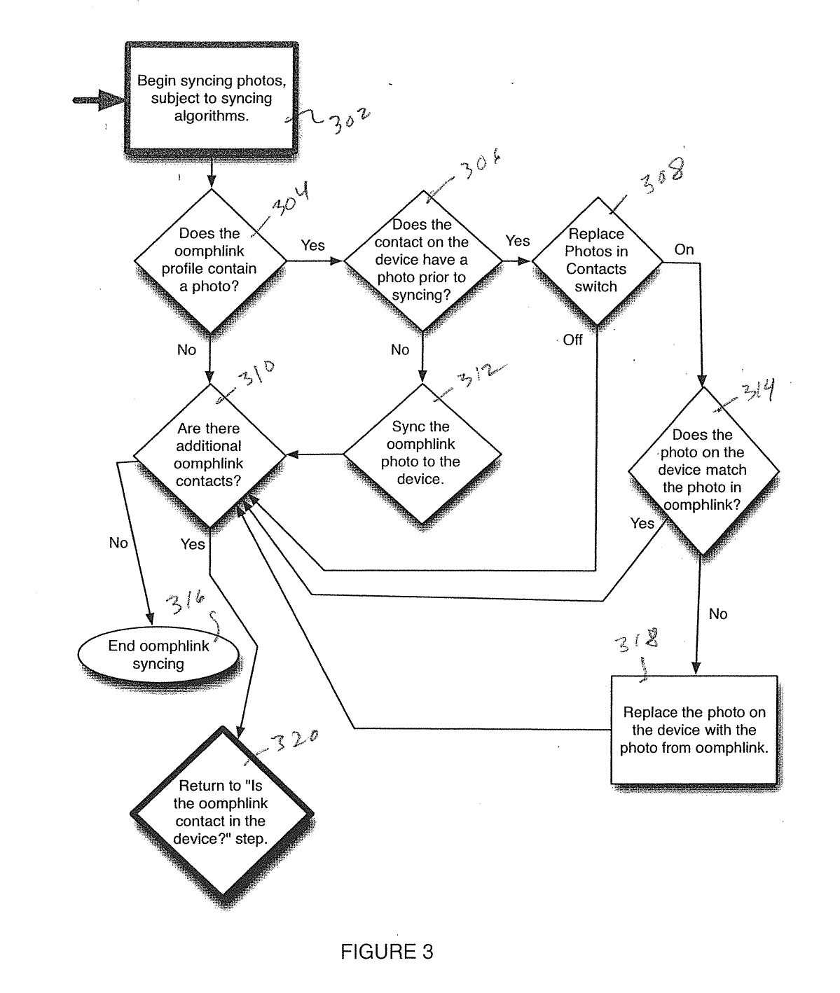

The flow diagram of FIG. 2 provides further syncing detail. At 202, a command is received to sync a contact subject to syncing algorithms. If data is to be replaced at 204, all information except photos is synced at 206, and all existing information except photos is removed. If the contacts switch is off, each piece of information except photos is compared at 208. If, at 210, the information is already in the device, no actions are taken with respect to that piece of information at 212. If the information is not in the device, it is added at 214 subject to the field mapping shown in FIG. 7. Regardless of whether the information was already present in the device, a query is made at 216 asking if there is more information and, if so, control flow return to 210. If not, photo syncing begins at 218, as shown in the flow diagram of FIG. 3.

Photo syncing commences at 302. If the oomphlink photo contains a photo at 304, control passes to 306. If not, the query at 310 asks if there are additional contacts and, if so, at 320, flow returns to question block 110 in FIG. 1. At 306, the method asks whether the contact on the device have a photo prior to syncing. If so, photos are replaced in contact switch at 308. If the switch is on, the question is asked at 314 if the photo in the device matches the photo in oomphlink. If not, the photo is replaced at block 318. Contrary decisions other than those just discussed from 308, 314 and 318 return to the question block at 310.

### Field Mapping

FIG. 7 is a diagram that shows field mapping. The oomphlink fields are shown at the left in column 702. The device fields are shown at 704, and the mapping is illustrated by the arrows from 702 to 704. For example, a photo at 706 may be mapped to “add photo” at 708. First and Last name device fields at 710, 712 are only changed when a new entry is created in the device—these map to oomphlink's First and Last name fields. Other device fields, such as ring tone 714 and text tone 716, are not used at 720. Additional details about the device and oomphlink fields is provided below.

### Device Fields

The device has two sections for each field, similar to oomphlink. The two fields in the device are a label for the information (such as home, work, etc.) and a space for the information (such as (111) 111-1111, etc.).

The device also allows custom labels to be added to any field that has a label, similar to oomphlink. Labels can be added for the following fields in the device: Phone, Email, home page, address/add new address, and custom/add field.

### Oomphlink Fields

The user's oomphlink sub-profile label is used as the label in the device field for the following oomphlink fields: E-Mail, Phone, and Address. Custom labels may be created in the device, as necessary, to correspond to the oomphlink sub-profile label.

Gender, date of birth, and education may be added to the custom/add field section of the device. The label for these oomphlink fields should be their names. “Gender” “Date of Birth” and “Education” Custom labels may be created in the device, as necessary, to correspond to the oomphlink sub-profile label.

Page Name may be mapped to the home page category. The label should be “oomphlink” A custom label should be created in the device, if necessary.

Facebook, Twitter, and Linkedln may be mapped to the home page category. The label for these oomphlink fields may be their names. “Facebook” “Twitter” and “Linkedln” Custom labels may be created in the device, as necessary, to correspond to the oomphlink sub-profile label.

The Custom field in oomphlink may be mapped to the custom/add field section of the device. The custom label created in oomphlink may be the label in the device. A custom label may be created in the device, if necessary.

1. A method enabling users to share and update contact information, comprising the steps of:
storing profile information for a plurality of users in a database;
searching, by one user, for other users in the database, and adding one or more of the other users as contacts, enabling the contacts to share at least some of the one user's profile information;
whereby, when the one user chooses to edit, add, or delete information from their stored profile information, the changes are automatically shared with the users designated as contacts by the one user.

2. The method of claim 1, wherein the profile information includes a phone number, e-mail address or social network address.

3. The method of claim 1, including the step of assigning the profile information to personal, business, or other sub-profiles.

4. The method of claim 1, including the step of enabling a given user to only share their information, only ask for the other user's information, or request a reciprocal relationship (sharing both ways).

5. The method of claim 1, including the steps of:
enabling a given user to only share their information, only ask for the other user's information, or request a reciprocal relationship (sharing both ways); and
accepting or denying information sharing by the other users.

6. The method of claim 1, including the step of maintaining prior or old profile information that may be searched but which is not automatically shared with other users.

7. The method of claim 1, including the step of updating a user's profile information through a syncing process.
